(19) United States
(12) Patent Application Publication
(10) Pub. No.: US 2015/0108209 A1
(43) Pub. Date: Apr. 23, 2015

(54) MULTIFUNCTIONAL POSTBOX HAVING LIGHT-EMITTING DIODE DISPLAY UNIT AND USING SOLAR CELL MODULE

(71) Applicant: Joung Sook Cho, Hwaseong-si (KR)

(72) Inventor: Joung Sook Cho, Hwaseong-si (KR)

(21) Appl. No.: 14/376,965

(22) PCT Filed: May 14, 2012
(86) PCT No.: PCT/KR2012/003751

§ 371 Date: Nov. 24, 2014

(30) Foreign Application Priority Data
Feb. 6, 2012 (KR) 10-2012-0012056

(51) Int. Cl. A47G 29/122; G09F 9/33; G09F 23/00; G09F 27/00

(52) U.S. Cl. CPC A47G 29/1212; G09F 27/007; G09F 9/33; G09F 23/00; A47G 2029/1226
USPC 232/34

(57) ABSTRACT

The present invention relates to a multifunctional postbox having a light-emitting diode display unit that is capable of displaying various pieces of information by driving a light-emitting diode using power acquired from a solar cell module. More particularly, the present invention relates to a multifunctional postbox comprising: a solar cell module arranged at an outer surface of a main body of the postbox, which collects solar heat and generates an electrical energy; a battery arranged in an internal space of the postbox for storing the electrical energy generated by the solar cell module; and an address display panel arranged at an outer surface of the main body of the postbox, which displays address information by driving a light-emitting diode.

### TECHNICAL FIELD

The present invention relates to a postbox, and more specifically, to a multi-functional postbox with an LED display unit that may drive LEDs using power from a solar cell module to display various pieces of information.

### DISCUSSION OF RELATED ART

A postbox is installed at a particular position to collect mails. For example, the postbox is positioned in a place away from the post office and is primarily used to provide a mail service. Further, a postbox is installed before a house to retain mails delivered. A mailbox is installed on the entrance door of an apartment or townhouse building.

However, when a mailman puts mails in the postbox or mailbox, it is impossible to check whether the mails have been delivered without opening the postbox or mailbox. Accordingly, due to the late discovery of bills that were overdue and legal documents, the user may be charged with late fees or legally disadvantaged. The user, when waiting for an important mail, needs to frequently open the mailbox to check whether the mail has come.

In a single house town, rather than an apartment complex, each house has typically its own postbox. However, the conventional postbox simply temporarily retains mails and does not offer any other additional functions.

Regarding the postbox or mailbox with such additional functions, Korean Patent Application Publication No. 2010-0131152 discloses a mailbox (filed by Goldenpost, Inc.) (Document 1) with a sensor, which creates a light flicker when a mail is put in the mailbox, thus making it possible to check whether a mail is received in the mailbox. However, the user cannot check in real-time whether a mail is inserted in the mailbox without, going to checking the mailbox. Further, the mailbox needs to have a separate power source to provide such additional function.

### SUMMARY

An object of the present invention is to provide an LED display unit-equipped multi-functional postbox using a solar cell module, which is installed at an entrance of each house, wherein the solar cell module and an address display panel are attached on the multi-functional postbox, and the address display panel is energized with the power collected by the solar cell module.

Further, an object of the present invention is to provide an LED display unit-equipped multi-functional postbox using a solar cell module, which is installed at an entrance of each house, wherein the multi-functional postbox has a barcode recognition unit and scans the barcode of a mail when the mail is inserted into the multi-functional postbox and displays the number of mails counted in the multi-functional postbox through a mail count panel, so that the number of mails retained in the multi-functional postbox may be easily checked.

Further, an object of the present invention is to provide an LED display unit-equipped multi-functional postbox using a solar cell module, which is installed at an entrance of each house, wherein the multi-functional postbox has a barcode recognition unit, and the multi-functional postbox may scan the barcode when a mail is inserted into the multi-functional postbox and notify the arrival of the mail to a user terminal.

To achieve the above-described objects of the present invention and unique effects of the present invention to be described below, the features of the present invention are as follows:

According to an aspect of the present invention, a multi-functional postbox comprises a solar cell module provided at an external side surface of a body of the multi-functional postbox and collecting solar heat to generate electrical energy; a recharger provided in an inner space of the multi-functional postbox to store the electrical energy generated by the solar cell module; and an address display panel provided at an external side surface of the body and driving an LED to display address information.

Preferably, the multi-functional postbox further comprises a mail count panel provided at an external side surface of the body to count and display the number of mails stored in the multi-functional postbox.

Preferably, the multi-functional postbox further comprises a slot provided at an external side surface of the body and having an opening through which a mail may be inserted into the inner space; a sensor installed adjacent to the slot at an inside or outside of the multi-functional postbox to sense a mail inserted through the slot; and a controller increasing the number of mails displayed on the mail count panel when insertion of a mail is sensed by the sensor.

Preferably, the controller transmits information on arrival of a mail to a predetermined user terminal through a wireless communication means when the insertion of the mail is sensed by the sensor.

Preferably, the information transmitted to the user terminal includes information on a time of the arrival of the mail and information on the number of mails currently counted in the multi-functional postbox.

Preferably, the multi-functional postbox further comprises a barcode recognition unit provided at an external side surface of the multi-functional postbox to scan and recognize a barcode attached to the mail; and a controller increasing the number of mails displayed on the mail count panel when the mail is identified by the barcode recognition unit.

Preferably, the controller transmits information on arrival of the mail to a predetermined user terminal when the mail is identified by the barcode recognition unit.

Preferably, the information transmitted to the user terminal includes information on a time of the arrival of the mail, information on the number of mails currently counted in the multi-functional postbox, and information relating to the mail identified through the barcode.

Preferably, the multi-functional postbox further comprises a GPS module receiving position information through a GPS satellite.

Preferably, the multi-functional postbox comprises an illumination sensor sensing a strength of illumination; a timer unit measuring a current time; and a controller performing control to provide the electrical energy stored in the recharger to the address display panel when the current time is measured to be in a daytime by the timer unit.

Preferably, the controller performs control to provide the electrical energy stored in the recharger to the address display panel when the current time is measured to be in the daytime by the timer unit and a value sensed by the illumination sensor is less than a predetermined value.

Preferably, the controller performs control to stop supplying power to the address display panel when the current time is measured to be in the daytime by the timer unit and a value sensed by the illumination sensor is equal to or more than a predetermined value.

Preferably, the multi-functional postbox further comprises an input unit provided at an external side surface of the body and enabling information to be input by a predetermined input means; and a storage unit storing the information input through the input unit, wherein the information stored in the storage unit is displayed through the address display panel.

As described above, according to the present invention, an address may be easily identified through the address display panel attached to the multi-functional postbox. In particular, the power collected by the solar cell module provided in the multi-functional postbox is supplied as power for driving the address display panel, thus allowing for the semi-permanent use even without supplying separate external power.

Further, according to the present invention, the barcode is scanned by the barcode recognition unit provided in the multi-functional postbox upon insertion of a mail, and the number of mails is displayed through the mail count panel. Accordingly, the number of mails retained in the multi-functional postbox may be easily checked.

Further, according to the present invention, the barcode is scanned by the barcode recognition unit provided in the multi-functional postbox upon insertion of a mail, and the arrival of the mail is notified to the user terminal. Accordingly, the user may conduct a real-time check on the status of arrival of the mail even without going to check the postbox. Thus, there is not concern about the loss of mails, and any disadvantage that may occur due to late discovery of the mail may be prevented.

Further, according to the present invention, the multi-functional postbox configures a display using clean energy, such as sunlight, thus contributing to savings in electrical energy and environmental conservation.

### BRIEF DESCRIPTION OF DRAWINGS

FIG. 1 is a block diagram illustrating a detailed configuration of functional modules provided in a multi-functional postbox according to an embodiment of the present invention.

FIG. 2 is a view illustrating a front surface of an address display panel of a multi-functional postbox according to an embodiment of the present invention.

FIG. 3 is a front view illustrating a mail count panel attached to a multi-functional postbox according to an embodiment of the present invention.

FIG. 4 is a perspective view illustrating a multi-functional postbox according to an embodiment of the present invention.

FIG. 5 is a flowchart illustrating a process of controlling the supply of power to an LED display unit attached to a multi-functional postbox according to an embodiment of the present invention.

FIG. 6 is a flowchart illustrating a process of transmitting mail information by a multi-functional postbox according to an embodiment of the present invention.

<Description of Symbols>

| | |
|---|---|
| 100: controller | 110: barcode recognition unit |
| 120: solar cell module | 130: recharger |
| 140: illumination sensor | 150: storage unit |
| 160: GPS module | 170: wireless communication unit |
| 180: input unit | 190: display unit |

| | |
|---|---|
| 200, 450: address display panel | 210, 310, 410: solar cell module |

| | |
|---|---|
| 22, 320: LED display unit | 230: GPS receiving unit |
| 240, 460: antenna | 300, 430: mail count panel |
| 400: postbox | 420: slot |

| | |
|---|---|
| 440: barcode recognition unit | 470: support |

471: fixture

### DETAILED DESCRIPTION OF EMBODIMENTS

The following detailed description refers to the accompanying drawings that illustrate particular embodiments of the present invention. Such embodiments are described in detail in such an extent that the present invention may be practiced by those of ordinary skill in the art. Although different embodiments from each other are described, it should be appreciated that the embodiments do not exclude each other. For example, the specific shapes, structures, and features disclosed herein may be implemented in other embodiments without departing from the spirit and scope of the present invention in connection with an embodiment. Further, it should be appreciated that the position or arrangement of individual components in each embodiment may be varied without departing from the spirit and scope of the present invention. Accordingly, the following detailed description does not intend to limit the scope of the present invention, and rather, the scope of the present invention is limited only by the appended claims together with the equivalents thereof. The similar reference numerals refer to the same or similar functions in various aspects.

The present invention proposes a multi-functional postbox having an address display panel implemented with LEDs on an external surface thereof, which may provide house-related information.

According to an embodiment of the present invention, a solar cell module is provided at a predetermined position of the multi-functional postbox and collects power and supplies the collected power to the address display panel. Accordingly, the address display panel may be driven even without a separate external power source.

Further, according to an embodiment of the present invention, a mail count panel is further provided at a predetermined position of the multi-functional postbox, and the number of mails inserted in the multi-functional postbox upon insertion of a mail is counted and is displayed through the mail count panel, so that the number of mails retained in the postbox may be easily recognized from the outside even without opening the postbox. In this case, various methods for counting the mails may be implemented. Preferably, a barcode recognition unit is further provided in the multi-functional postbox, thus allowing the number of mails to be automatically counted up and displayed when the barcode attached to the mail is recognized by the barcode recognition unit. As another method, a sensor may be installed at a slot through which mails are inserted to count mails whenever the mails are inserted.

Further, according to an embodiment of the present invention, if the barcode attached to a mail is recognized by the barcode recognition unit, the content relating to the mail may be transmitted to a predetermined user terminal through a wireless communication means provided in the multi-functional postbox, so that the user may conduct a real-time check on the arrival and/or content of the mail.

Meanwhile, the address display panel attached to the multi-functional postbox to indicate an address may be implemented using various display means. For example, the address display panel may be configured of light emitting diodes (hereinafter, LEDs), and the power to be supplied to the LEDs may be generated by a solar cell module. Accordingly, the address display panel may be identified at night even without supplying separate external power.

For example, the address and shop name is not easy to recognize in a significantly wide area such as the north America, and accordingly, the addresses and shop names of a majority of homes in a wide area, dangerous situation and traffic information may be rendered to be easily displayed the outdoors through address display panels according to the present invention. Accordingly, the address display panel according to an embodiment of the present invention may further include an input means that allows the user to vary information.

In other words, according to the present invention, an address and number may be displayed by an English character and number module, which may be installed in the multi-functional postbox at low costs and in an easy-to-assemble manner. Powering is conducted using a solar cell module that serves as a self-power source without supply of the external power.

Meanwhile, an LED display may be driven at a low voltage and power and may be thus operated sufficiently by a solar cell. Accordingly, according to an embodiment of the present invention, a solar cell module and an LED display module are integrated into a single body, so that an address display panel may be implemented in a single module.

Before advancing to the description of the present invention, a solar cell module is described.

Depending on the constituting materials, solar cells may be classified into inorganic solar cells formed of inorganic materials such as silicon or compound semiconductors and organic solar cells including organic materials. The organic solar cells may be classified into dye-sensitized solar cells and organic D-A solar cells. In addition to the classification depending on the materials constituting the solar cells, the solar cells may be classified into three different types of solar cells depending on their structure, such as a wafer structure (bulk silicon solar cells), a thin film structure (compound solar cells, organic polymer solar cells, etc.), and a photoelectrochemical structure (dye-sensitized solar cells).

The wafer-based solar cells occupy about 87% of the entire solar cell module market share, but the thin film solar cells provide a significant advantage in the following two aspects. In the first aspect, the thin film solar cells have a low proportion of material costs in the manufacturing costs. In the second aspect, the thin film solar cells, since their modules are produced using the raw material, in view of the business value chain, rely little on the lower value chain on business as compared with the wafer-based solar cells having the businesses of manufacturing wafers and cells.

The solar cell module according to the present invention may be implemented by various methods, and the present invention may be applicable to any other solar cell modules implemented by any other methods, as well as the above-described wafer-structure, thin film-structure, or photoelectrochemical-structure solar cell modules.

Hereinafter, preferred embodiments of the present invention are described in detail with reference to the accompanying drawings so as to be easily practiced by those of ordinary skill in the art.

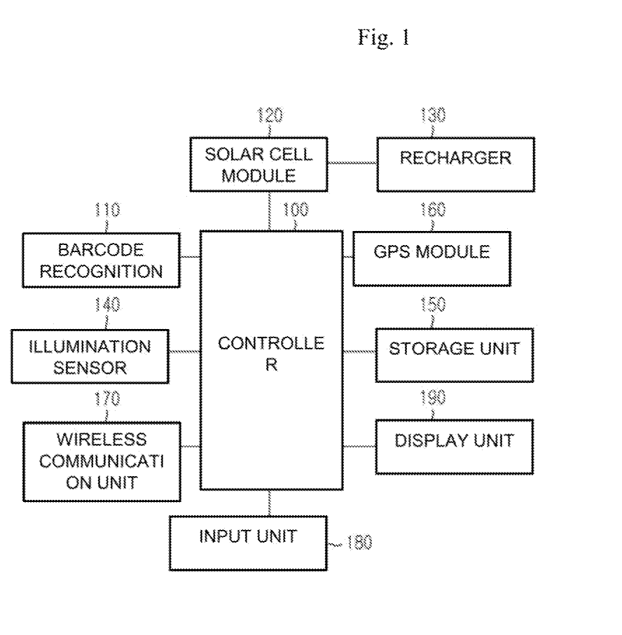

FIG. 1 is a block diagram illustrating a detailed configuration of functional modules provided in a multi-functional postbox according to an embodiment of the present invention. Referring to FIG. 1, according to an embodiment of the present invention, the functional modules in the multi-functional postbox may include a controller 100, a barcode recognition unit 110, a solar cell module 120, a recharger 130, an illumination sensor 140, a storage unit 150, a GPS module 160, a wireless communication unit 170, an input unit 180, and a display unit 190.

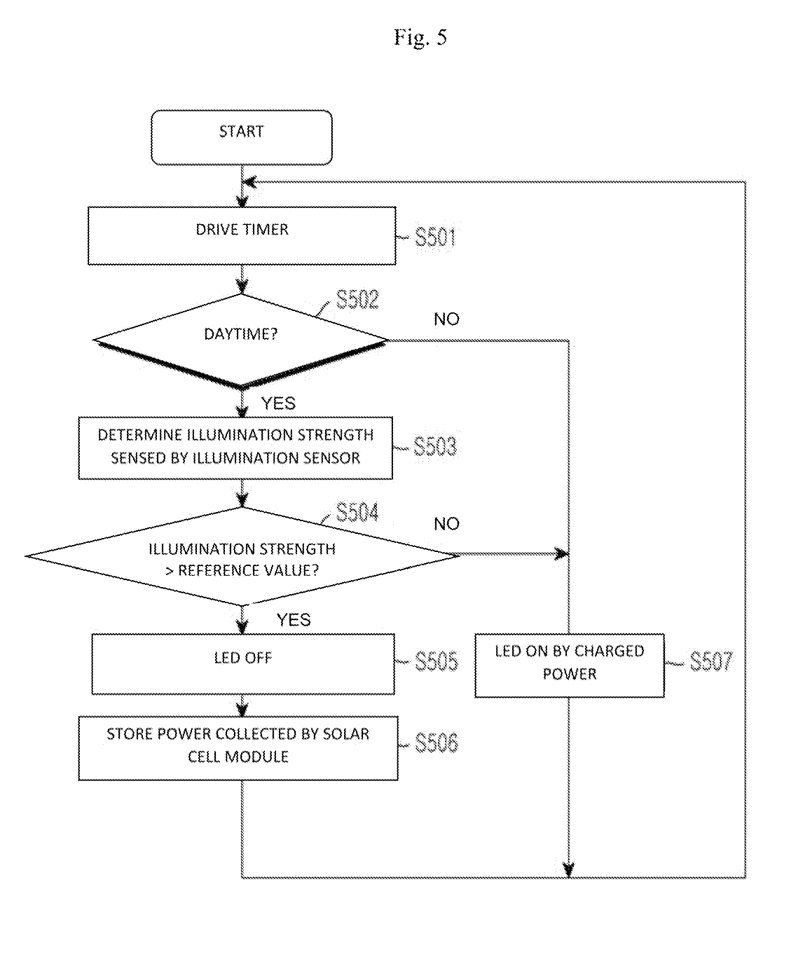

The solar cell module 120 may be configured in various fashions as described above. The solar cell module 120 collects solar heat, converts the collected solar heat into electrical energy, and stores the electrical energy in the recharger 130. Meanwhile, as described later in connection with FIG. 5, an illumination sensor (not shown) and a timer unit (not shown) may be driven to control the ON/OFF of the display unit 190.

In other words, in case it is determined to be in the daytime by the operation of the timer unit, it is not required to supply power to the display unit 190. However, in case the strength of illumination is significantly low due to, e.g., cloudy weather, even in the daytime, it is preferable to supply power to the display unit 190 to turn on a light emitting means such as LEDs. Accordingly, the controller 100 is rendered to control the supply of power to the display unit 190 according to values sensed by the illumination sensor and the operation of the timer unit.

Meanwhile, according to another embodiment of the present invention, it may be implemented to control the supply of power to the display unit 190 only with the values sensed by the illumination sensor without providing the timer unit. For example, the controller 100 may perform control so that the LEDs emit light only when a value sensed by the illumination sensor is less than a predetermined value.

The GPS module 160 may replace the function of the timer unit by receiving a synced time value. For example, the supply of power to the display unit 190 may be controlled by receiving a standard time value from the GPS module 160 to calculate the sunrise and sunset time of each day or by referring to a time value stored in the storage unit 150. Further, the time value received by the GPS module 160 may be utilized for displaying mail-related information.

Meanwhile, according to a result of the determination by the controller 100, the power collected by the solar cell module 120 is stored in the recharger 130 in the daytime while cutting off the supply of power to the display unit 190. In contrast, the power charged to the recharger 130 is supplied to the 190 at night so that an address may be identified even at night.

The information displayed through the display unit 190 may be configured in various manners. For example, the address information stored in the storage unit 150 may be read out and displayed, or it may be implemented to display different pieces of information from each other at each predetermined time in interoperation with the timer unit.

Further, it may be implemented to input the user's desired information through the input unit 180 and to output the user's input information through the display unit 190. Accordingly, according to the present invention, the information displayed through the address display panel may be not merely fixed information but also information additionally input from the outside or information arbitrarily configured by the user.

The barcode recognition unit 110 is provided at an outside of the multi-functional postbox to recognize a barcode attached to a mail and to store information relating to the mail in the storage unit 150. In case the mail is identified to be a normal one by scanning the barcode according to an embodiment of the present invention, the number of mails stored in the multi-functional postbox is counted up by one. The information on the number of mails counted may be displayed through the display unit 190.

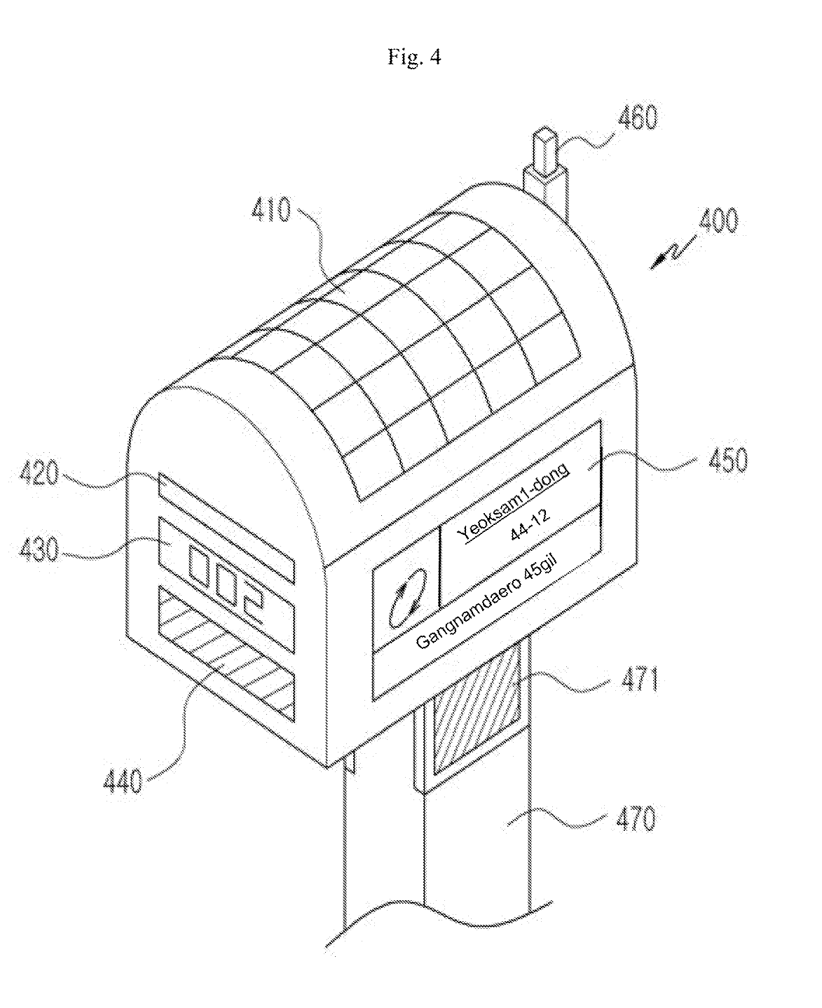

Meanwhile, according to an embodiment of the present invention, there may be a plurality of display units 190. For example, as shown in FIG. 4, an address display panel for displaying an address and a mail count panel for displaying the number of mails put in the multi-functional postbox may be provided separately from each other.

According to an embodiment of the present invention, the information on the mail recognized through the barcode recognition unit 110 may be transmitted to a predetermined user terminal through the wireless communication unit 170. In this case, the information on the user terminal may be previously configured and stored in the storage unit 150. Accordingly, when the barcode attached to the mail is identified, detailed information on the identified mail and information on the time measured by the GPS module 160 are transmitted in real-time to the user terminal through the wireless communication unit 170.

Accordingly, the user may conduct a real-time check on the status of delivery of his mails wherever he is and may verify the time of delivery of mails and information on the type of mails.

Meanwhile, the wireless communication unit 170 may provide a wireless data transmission/reception function that may perform near-field wireless communication with the user terminal (e.g., a smartphone). Information may be received from the user terminal through the wireless communication unit 170 and may be stored in the storage unit 150. Further, the information stored in the storage unit 150 may be displayed through the display unit 190. Meanwhile, in case the received information is software information on the address display panel device, the software may be renewed or reinstalled through the controller 100.

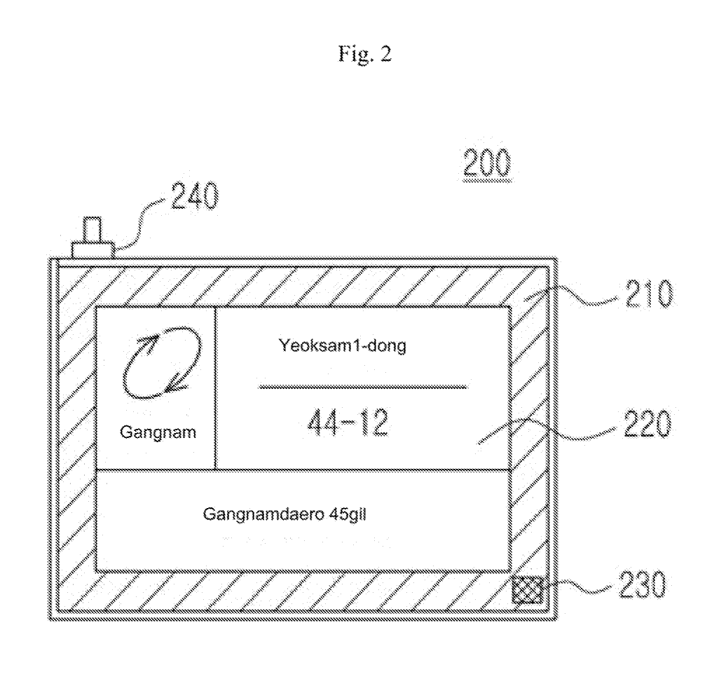

FIG. 2 is a view illustrating a front surface of an address display panel of a multi-functional postbox according to an embodiment of the present invention. Referring to FIG. 2, an LED display unit 220 is provided on the front surface of the address display panel attached to the multi-functional postbox, and address information, traffic information, or other various types of information input by the user may be displayed through the LED display unit 220. Further, a solar cell module 210 may be provided at the periphery of the LED display unit 220.

As described above, power is collected through the solar cell module 210 and stored in the recharger in the daytime, and the power stored in the recharger is supplied to the LED display unit 220 at night, so that an address may be identified even at night.

Further, according to an embodiment of the present invention, a GPS receiving unit 230 may be further provided to utilize various types of information received from a GPS satellite. For example, information on a standard time and information on the position where the address display panel is installed may be obtained.

Further, according to an embodiment of the present invention, an antenna 240 may be further provided to perform wireless communications. Accordingly, the user may transmit various data to the address display panel through near-field wireless communication or may transmit mail-related information recognized through scanning the barcode attached to the mail to a predetermined user terminal.

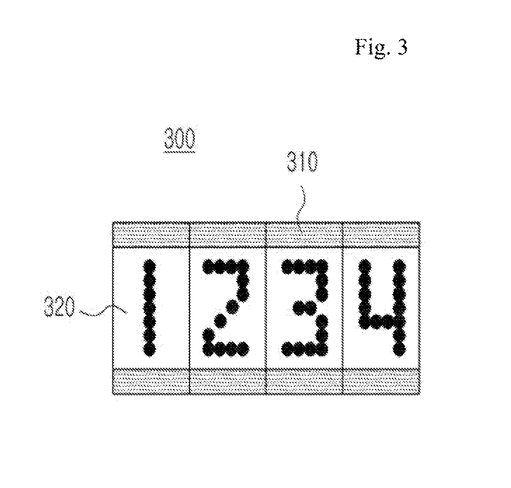

An example of implementing a mail count panel attached to a multi-functional postbox is now described with reference to FIG. 3.

FIG. 3 is a front view illustrating a mail count panel attached to a multi-functional postbox according to an embodiment of the present invention. Referring to FIG. 3, the number of mails stored in the multi-functional postbox may be displayed through an LED display unit 320, e.g., in numbers. A solar cell module 310 panel may be implemented at an upper or lower end of the LED display unit 320. The number of mails displayed on the LED display unit 320 may be counted, increased, and displayed when the barcodes attached to the mails are scanned by the barcode recognition unit upon arrival of the mails as described above.

FIG. 4 is a perspective view illustrating a multi-functional postbox according to an embodiment of the present invention. Referring to FIG. 4, the body of a multi-functional postbox 400 according to an embodiment of the present invention may be fixed to, e.g., ground, by a support 470. In this case, the body of the multi-functional postbox 400 may be fixed to the support 470 by way of a predetermined fixture 471.

Meanwhile, as set forth above, the multi-functional postbox 400 according to an embodiment of the present invention may include a solar cell module 410, an address display panel 450, a mail count panel 430, a barcode recognition unit 440, and an antenna 460.

The address display panel 450 may display various pieces of configured information including address information as described above. The address display panel 450 may be implemented by various display means. For example, the address display panel 450 may be implemented of LEDs. In this case, the power for driving the address display panel 450 may be collected and supplied by the solar cell module 410 provided at an upper side of the multi-functional postbox 400.

Meanwhile, the mail count panel 430 and the barcode recognition unit 440 may be provided at a lower end of a slot 420 provided at a side of the multi-functional postbox 400. Accordingly, if the mailman brings the barcode of a mail close to the barcode recognition unit 440 before inserting the mail into the slot 420 so that the barcode is scanned, the mail count panel 430 counts up by one. Further, according to an embodiment of the present invention, the information relating to the scanned mail may be transmitted to a predetermined user terminal through the antenna 460.

Further, as another method, when a mail is inserted through the slot 420 without scanning by the barcode recognition unit 440, it may be implemented to count the mail through a sensor provided adjacent to the slot 420. In this case, the mail-related information might not be transmitted, but information regarding the fact and time of arrival of the mail may be transmitted in real-time to the user.

FIG. 5 is a flowchart illustrating a process of controlling the supply of power to an LED display unit attached to a multi-functional postbox according to an embodiment of the present invention. Referring to FIG. 5, a timer is first driven (S501), and as the timer is driven, unless the current time is in the daytime (S502), an LED display unit is turned on by the power charged by a solar cell module (S507).

In contrast, in case the timer is driven and the current time is in the daytime, the LEDs in the LED display unit are preferably turned off. However, in case the strength of illumination is low due to external causes even in the daytime, the LEDs in the LED display unit are preferably turned on. In other words, a strength of illumination as sensed by an illumination sensor is determined (S503), and in case the sensed strength of illumination is a preset reference value or less, the LEDs in the LED display unit are turned on (S507). However, in case the sensed strength of illumination is in excess of the preset reference value (S504), the LEDs in the LED display unit are turned off (S505), and the power collected by the solar cell module are stored in the recharger (S506).

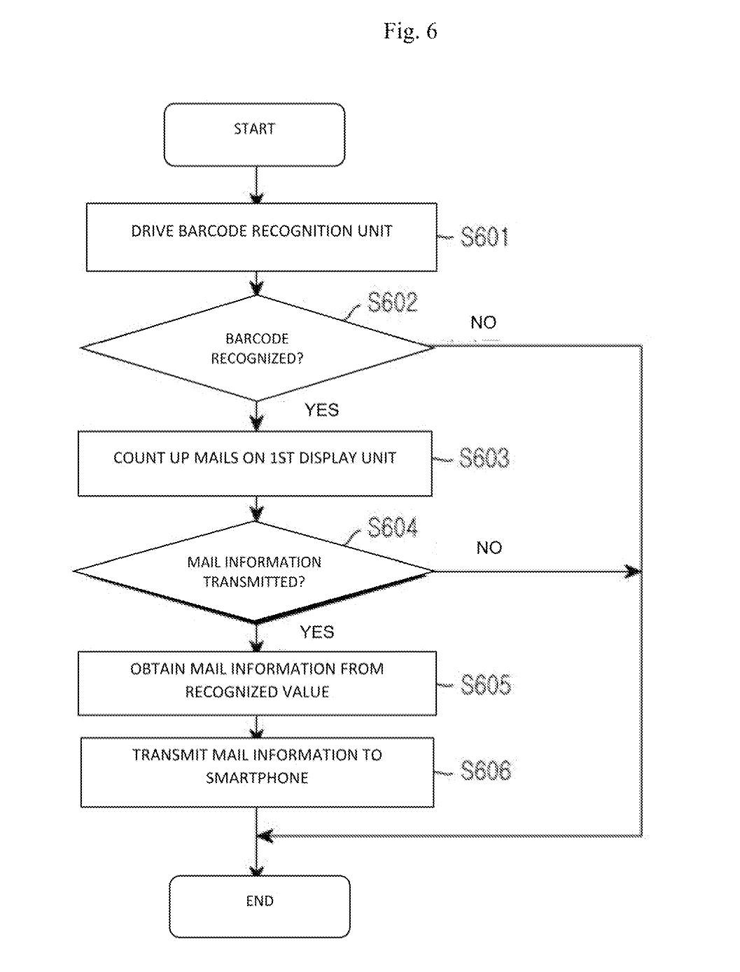

FIG. 6 is a flowchart illustrating a process of transmitting mail information by a multi-functional postbox according to an embodiment of the present invention. Referring to FIG. 6, a barcode recognition unit is driven (S601). If the barcode attached to the mail is scanned and the scanned barcode is recognized (S602), a first display unit (e.g., the mail count panel) counts up (S603). Then, in case mail-related information intends to be transmitted (S604), mail information is obtained from a value recognized from the mail (S605), and the obtained mail information is transmitted to a predetermined user terminal (e.g., a smartphone, etc.) (S606).

By doing so, the number of mails currently stored in the multi-functional postbox may be identified through the multi-functional postbox, and arrival of a mail may be checked by the user in real-time.

Although particular embodiments of the present invention have been described with reference to a limited number of drawings, the embodiments are provided merely for aiding in understanding the overall present invention, and the present invention is not limited thereto, and various changes or modifications may be made thereto by those of ordinary skill in the art.

Accordingly, the spirit of the present invention should not be limited to the above-described embodiments, and it should be understood that the invention defined by the following claims and all equivalents thereof belong to the scope of the present invention.

What is claimed is:

1. A multi-functional postbox, comprising:
a solar cell module provided at an external side surface of a body of the multi-functional postbox and collecting solar heat to generate electrical energy;
a recharger provided in an inner space of the multi-functional postbox to store the electrical energy generated by the solar cell module; and
an address display panel provided at an external side surface of the body and driving an LED to display address information.

2. The multi-functional postbox of claim 1, further comprising a mail count panel provided at an external side surface of the body to count and display the number of mails stored in the multi-functional postbox.

3. The multi-functional postbox of claim 2, further comprising:
a slot provided at an external side surface of the body and having an opening through which a mail may be inserted into the inner space:
a sensor installed adjacent to the slot at an inside or outside of the multi-functional postbox to sense a mail inserted through the slot; and
a controller increasing the number of mails displayed on the mail count panel when insertion of a mail is sensed by the sensor.

4. The multi-functional postbox of claim 3, wherein the controller transmits information on arrival of a mail to a predetermined user terminal through a wireless communication means when the insertion of the mail is sensed by the sensor.

5. The multi-functional postbox of claim 4, wherein the information transmitted to the user terminal includes information on a time of the arrival of the mail and information on the number of mails currently counted in the multi-functional postbox.

6. The multi-functional postbox of claim 2, further comprising:
a barcode recognition unit provided at an external side surface of the multi-functional postbox to scan and recognize a barcode attached to the mail; and
a controller increasing the number of mails displayed on the mail count panel when the mail is identified by the barcode recognition unit.

7. The multi-functional postbox of claim 6, wherein the controller transmits information on arrival of the mail to a predetermined user terminal when the mail is identified by the barcode recognition unit.

8. The multi-functional postbox of claim 7, wherein the information transmitted to the user terminal includes information on a time of the arrival of the mail, information on the number of mails currently counted in the multi-functional postbox, and information relating to the mail identified through the barcode.

9. The multi-functional postbox of claim 1, further comprising a GPS module receiving position information through a GPS satellite.

10. The multi-functional postbox of claim 1, comprising:
an illumination sensor sensing a strength of illumination;
a timer unit measuring a current time; and
a controller performing control to provide the electrical energy stored in the recharger to the address display panel when the current time is measured to be in a daytime by the timer unit.

11. The multi-functional postbox of claim 10, wherein the controller performs control to provide the electrical energy stored in the recharger to the address display panel when the current time is measured to be in the daytime by the timer unit and a value sensed by the illumination sensor is less than a predetermined value.

12. The multi-functional postbox of claim 10, wherein the controller performs control to stop supplying power to the address display panel when the current time is measured to be in the daytime by the timer unit and a value sensed by the illumination sensor is equal to or more than a predetermined value.

13. The multi-functional postbox of claim 1, further comprising:
an input unit provided at an external side surface of the body and enabling information to be input by a predetermined input means; and
a storage unit storing the information input through the input unit, wherein the information stored in the storage unit is displayed through the address display panel.
